(19) United States
(12) Patent Application Publication
(10) Pub. No.: US 2018/0083954 A1
(43) Pub. Date: Mar. 22, 2018

(54) METHOD, SYSTEM, LOGIN DEVICE, AND APPLICATION SOFTWARE UNIT FOR LOGGING INTO DOCBASE MANAGEMENT SYSTEM

(71) Applicant: SurCloud Corp., Union City, CA (US)

(72) Inventor: Donglin WANG, Tianjin (CN)

(21) Appl. No.: 15/802,371

(22) Filed: Nov. 2, 2017

Related U.S. Application Data
(63) Continuation-in-part of application No. 14/034,428, filed on Sep. 23, 2013.
Application No. 14/034,428 is a continuation-in-part of application No. 12/133,296, filed on Jun. 4, 2008, now Pat. No. 8,645,344.
Application No. 12/133,296 is a continuation of application No. PCT/CN2012/072602, filed on Mar. 20, 2012.
Application No. 12/133,296 is a continuation of application No. PCT/CN2006/003297, filed on Dec. 5, 2006.

(30) Foreign Application Priority Data
Dec. 5, 2005 (CN) 200510126683.6
Dec. 9, 2005 (CN) 200510131072.0
Mar. 21, 2011 (CN) 201110067712.1

(51) Int. Cl. H04L 29/06; G06F 21/62; G06F 21/34; G06F 17/30

(52) U.S. Cl. CPC H04L 63/0815; G06F 21/62; H04L 63/083; G06F 17/30011; G06F 21/34

(57) ABSTRACT

The present invention provides a method, system and login device for logging into a docbase management system. the method includes: establishing a login device which has a unified invocation interface; invoking, by a user, the login device via an application software unit, wherein the application software unit invokes the login device via the unified invocation interface; returning, by the login device, to the application software unit, access information of a role corresponding to the user achieved after successfully logging in the docbase management system; accessing, by the application software unit, the docbase management system by using the access information.

### CROSS-REFERENCE TO RELATED APPLICATION

This application is a continuation in part of U.S. patent application Ser. No. 14/034,428, filed on Sep. 23, 2013, which is a continuation of PCT/CN2012/072602, filed on Mar. 20, 2012, which claims priority from Chinese patent application 201110067712.1, filed on Mar. 21, 2011, the entire contents of which are incorporated herein by reference for all purposes. The U.S. application Ser. No. 14/034,428 is also a continuation in part of U.S. patent application Ser. No. 12/133,296, filed on Jun. 4, 2008, which is a continuation of PCT/CN2006/003297, filed on Dec. 5, 2006, which claims priority from Chinese patent application 200510126683.6, filed on Dec. 5, 2005 and 200510131072.0, filed on Dec. 9, 2005, the contents of which are incorporated herein by reference for all purposes.

### FIELD OF THE INVENTION

The present invention relates to the docbase management system technology, and more particularly, to a method, system, login device, and application software unit for logging into a docbase management system.

### BACKGROUND OF THE INVENTION

The patent application for invention with the PCT application number of PCT/CN2006/003294 discloses a method and system for document data security management. To guarantee the security of objects of all levels including a document warehouse, docbase, document and page in the docbase management system, the abovementioned application for invention discloses a document data security management method as follows.

Several roles are created in docbase management system, where each role is identified with its unique ID. Each role has one or more keys. Each key corresponds to a unique access permission (view permission, write permission, re-authorization permission, and print permission, etc.), which is used for the fine-grained security access control for the docbase management system and objects of all levels in the docbase management system. For example, the said keys may be used for logging into the docbase management system, viewing the document, and signing the document, respectively.

When accessing the docbase management system, the application software unit authenticates the user firstly. After a successful authentication, the application software unit sends the login request carrying the role information to the docbase management system. The docbase management system judges whether the login is successful according to the role information, and returns the access information, such as session channel information, to the application software unit after a successful login. The application software unit then uses the access information to access the docbase management system.

Existing technologies usually need to set a corresponding authentication module in the application software unit for user authentication. For example, the application software units, including the Office Automation System, need to develop an authentication module to realize a specific authentication. Hence, the user needs to modify the existing authentication module when choosing a new authentication method.

There are some other methods in the prior art. For example, an application software unit opens its own authentication module to be invoked by other application software units. However, the other application software units invoking the authentication module depends on the specific application software unit, and should be modified when the specific application software unit changes. In addition, a login device may be constructed. The user may log in through the login device, and then the login device logs into application software units according to the mechanism of the application software units respectively. However, it cannot be known which application software units will be logged in, the login device cannot be developed to support unknown application software unit.

It is obvious that in the prior art the authentication module is unable to multiplex the authentication method, or costs a lot due to the large coupling, or cannot support unknown application software units. In conclusion, in the prior art, it is unable for various kinds of application software units to rapidly and efficiently log into the docbase management system.

### SUMMARY OF THE INVENTION

Embodiments of the present invention provide a method and a system for logging into the docbase management system, a login device and an application software unit, which make various kinds of application software units rapidly and efficiently log into the docbase management system.

The embodiment of the present invention provides a method for logging into a docbase management system, wherein the docbase management system is established on a server side and the method includes:

establishing a login device, which has a unified invocation interface, on a client side; invoking, by a user, the login device via an application software unit, wherein the application software unit invokes the login device via the unified invocation interface;

returning, by the login device, to the application software unit, access information of a role corresponding to the user achieved after successfully logging in the docbase management system;

accessing, by the application software unit, the docbase management system by using the access information;

when invoked by a user at the first time via an application software unit, authenticating, by the login device, the user, and logging into the docbase management system by using role information of the docbase management system corresponding to the user after a successful authentication; returning, by the login device, the access information corresponding to the user from the docbase management system to the application software unit, and storing the access information; when invoked again by the user via another application software unit, retrieving, by the login device, the stored access information and returns the access information back to the another application software unit used by the user who invokes again.

The embodiment of the present invention provides a login device for logging into a docbase management system, wherein the docbase management system is established on a server side and the login device includes:

a unified invocation interface, adapted for invoking the login device by an application software unit;

an authentication module, adapted to perform user authentication when logged into by a user through the application software unit at the first time;

a login module, adapted to log into the docbase management system by using role information of the document management corresponding to the user after a successful authentication, and store the access information from the docbase management system after a successful login;

an access information processing module, adapted to retrieve the stored access information when the user logs in again through another application software unit, and return the access information back to the another application software unit.

The embodiment of the present invention provides a system for logging into a docbase management system, wherein the docbase management system is established on a server side and the system for logging into the docbase management system includes: at least one login device established on a client side and at least two application software units;

wherein the login device comprises:

a unified invocation interface, adapted for invoking the login device by the at least two application software units;

an authentication module, adapted to perform user authentication when logged into by a user through an application software unit of at least two application software units at the first time;

a login module, adapted to log into the docbase management system by using role information of the document management corresponding to the user after a successful authentication, and store the access information from the docbase management system after a successful login; and

an access information processing module, adapted to retrieve the stored access information when the user logs in again through another application software unit of the at least two application software units, and return the access information back to the another application software unit;

wherein the application software unit comprises:

a login device invocation interface, adapted to invoke the at least one login device via a unified invocation interface;

an access information acquisition module, adapted to obtain access information from the docbase management system from the at least one login device; and

a document management access module, adapted to access the docbase management system by using the access information.

By using the technical scheme of the embodiments of the present invention, the relationship among the user information, role information of the docbase management system, and the access information is established via the login device. Therefore, the user only needs to perform the authentication and login operations once when log into the same docbase management system via different application software unit, which makes the role information shared better among application software units. Meanwhile, by providing the login device with unified invocation interface, any application software unit can log in through such login device, and transmit the access information via the unified interface. In this case, the authentication method is shared among application software units. Various kinds of application software units can rapidly and efficiently log into the docbase management system. Furthermore, the application software unit does not need to focus on the specific authentication method.

### BRIEF DESCRIPTION OF THE DRAWINGS

FIG. 1 illustrates the flowchart of a method for logging into a docbase management system provided in one embodiment of the present invention.

FIG. 2 is a flow chart of the method for document data security management provided by the present invention.

FIG. 3 illustrates the structure of a system for logging into a docbase management system provided in one embodiment of the present invention.

FIG. 4 illustrates the structure of a login device provided in one embodiment of the present invention.

FIG. 5 illustrates the structure of an application software unit provided in one embodiment of the present invention.

### DETAILED DESCRIPTION OF THE INVENTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments make reference to certain events this is not intended to be a limitation of the embodiments of the present invention and such is equally applicable to any event where goods or services are offered to a consumer.

Further, the order of the steps in the present embodiment is exemplary and is not intended to be a limitation on the embodiments of the present invention. It is contemplated that the present invention includes the process being practiced in other orders and/or with intermediary steps and/or processes.

The present invention is further described hereinafter in detail with reference to accompanying drawings and embodiments.

Embodiments of the present invention provide a method and system for security management applied to a document processing system.

Problems existing among prior document processing applications include: poor universality, difficulties in extracting document information, inconsistent access interfaces, difficulties or high cost on achieving data compatibility, impaired transplantability and scalability, underdeveloped page layered technique and too monotonous search method. In the prior art, one single application implements functions of both user interface and document storage, the present invention solves the problems by dividing a document processing application into an application layer and a docbase management system layer. The present invention further sets up an interface standard for interaction between the two layers and may even further create an interface layer in compliance with the interface standard. The docbase management system is a universal technical platform with all kinds of document processing functions and an application issues an instruction to the docbase management system via the interface layer to process a document, then the docbase management system performs corresponding operation according to the instruction. In this way, as long as different applications and docbase management systems follow the same standard, different applications can process a same document through a same docbase management system, therefore document interoperability is achieved. Similarly, one application may process different documents through different docbase management systems without independent development on every document format.

Furthermore, the technical scheme of the present invention provides a universal document model which makes different applications compatible with different documents to be processed. The interface standard is based on the document model so that different applications can process a same document via the interface layer. The universal document model can be applied to all types of document formats so that one application may process documents in different formats via the interface layer. The interface standard defines various instructions based on the universal document model for operations on corresponding documents and the way of issuing instructions by an application to a docbase management system(s). The docbase management system has functions to implement the instructions from the application. The universal model includes multiple hierarchies such as a docset including a number of documents, a docbase and a document warehouse. And the interface standard includes instructions covering organization management, query and security control, of multiple documents. In the universal model, a page is separated into multiple layers from bottom to top and the interface standard includes instructions for operations on the layers, storage and extraction of a source file corresponding to a layer in a document. In addition, the docbase management system has information security management control functions for documents, e.g., role-based fine-grained privilege management, and corresponding operation instructions are defined in the interface standard.

According to the present invention, the application layer and the data processing layer are separated with each other. An application no longer needs to deal with document formats directly and a document format is no longer associated with a specific application. Therefore a document can be processed by different applications and an application can process documents in different formats and document interoperability is achieved. The whole document processing system can further process multiple documents instead of one document. When a page in a document is divided into multiple layers, different management and control policies can be applied to different layers to facilitate operations of different applications on the same page (it can be designed that different applications manage and maintain different layers) and further facilitate source file editing and it is also a good way to preserve the history of editing.

Embodiments of the present invention also provide a method of logging into a docbase management system, applied to a document processing system including at least one client side and a server side. The docbase management system is established on the server side. In an embodiment, a login device with a unified invocation interface is created on a client side; a user invokes the login device via an application software unit, wherein the application software unit invokes the login device via the unified invocation interface; the login device returns the access information of the role corresponding to the user achieved after the successful log into the docbase management system; the application software unit uses the access information to access the docbase management system. When invoked for the first time (for example, a user logs into the login device through any application system unit), the login device authenticates the user, and logs into the docbase management system by using the role information corresponding to the user after a successful authentication; after a successful login, the login device returns the access information of the role corresponding to the user from the docbase management system to the application software unit, and stores the access information; when invoked again (for example, the same user logs into the login device through the same or other application system units), the login device retrieves the stored access information and returns the access information to the application software unit.

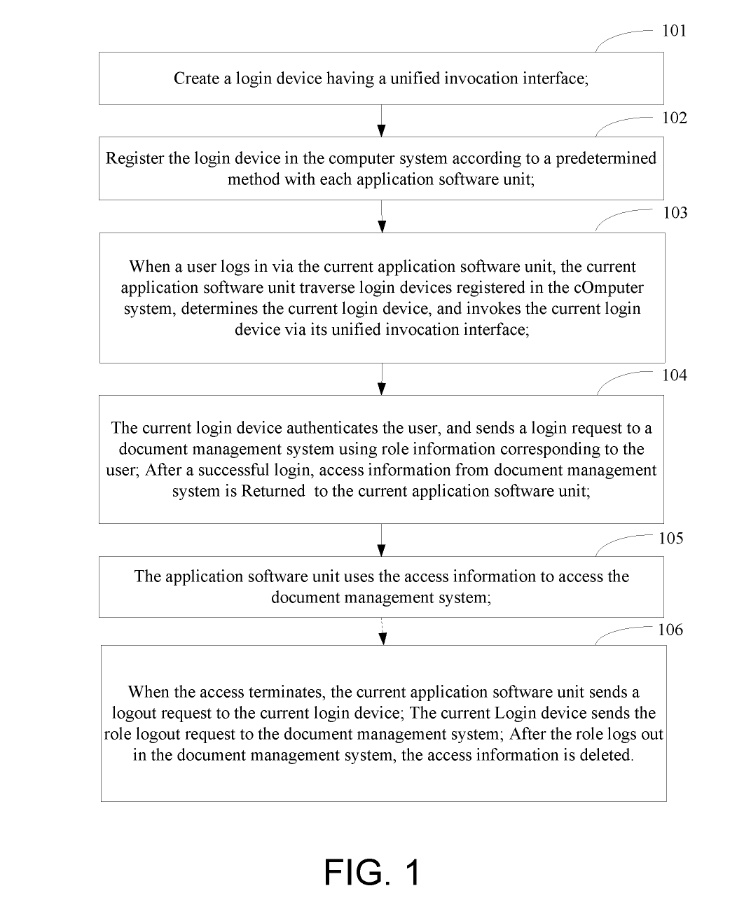

FIG. 1 illustrates the flowchart of a method for logging into a docbase management system provided in one embodiment of the present invention. As shown in FIG. 1, the method including the following steps:

Step 101: create a login device with a unified invocation interface. In one embodiment of the present invention, the login device may be in the form of the login component. The login device, as a unified name, is adopted in the present invention for simplicity.

Step 102: Register the login device in the computer system according to a method predetermined with each application software unit.

This step may be implemented with many methods. Three of them are listed as follows.

Method 1: Register location information of the login device in the registry of the computer system according to a method predetermined with each application software unit. The location information may be the location information of the login device program file.

Method 2: Register the location information of the login device in a specified directory of the computer system according to a method predetermined with each application software unit.

Method 3: Install the login device in a specified directory of the computer system according to a method predetermined with each application software unit.

The location information of the login device includes: the name and/or the location of the login device. The name of the login device is used to identify the login device, and the location of the login device, which usually is the path information, is used to locate the login device.

Step 103: When the user logs in through the current application software unit, the application software unit traverses login devices registered in the computer system according to a method predetermined with the login devices, determines one login device as the current login device, and invokes the current login device through the its unified invocation interface.

In this step, the current application software unit traverses registered login devices in the computer system according to a method predetermined with the login devices. If there are multiple registered login devices, the information of the login devices traversed is provided to the user, and the one selected by the user is determined as the current login device. Another way is to select one login device randomly as the current login device or according to preset rules. If there is only one registered login device, the only one login device is determined directly as the current login device.

After the current login device is determined, the current login device is invoked through the unified invocation interface of the login device, and the user will log in the docbase management system via the current login device.

Step 104: The current login device authenticates the user, and sends a login request to the docbase management system by using role information corresponding to the user in the docbase management system after a successful authentication. After a successful login, the access information returned from the docbase management system is provided to the current application software unit. Once obtaining the access information, the role logged in has the permission to access the docbase management system, and the application software unit has permissions of the logged in role.

In this step, the current login device may authenticate the user according to the stored authentication information. The login device may use many authentication methods, such as the method of user name and password, the method of user name and hardware bound, or the method of fixed password. The selection of authentication method depends on the actual needs. The authentication process is only related with the interaction between the login device and the user. The application software unit does not need to involve in the specific authentication method. Hence, the user authentication method based on the login device shields the implementation difference among different authentication methods adopted by different application software units.

The login device may store corresponding relation between the users and roles of the docbase management system. In this case, the current login device may obtain the role information of the docbase management system corresponding to the user according to the stored corresponding relation after a successful user authentication. Or, the corresponding relation also may be stored in the application software unit or other functional units instead of the login device. In this case, the current login device may achieve the role information of the docbase management system corresponding to the user from the application software unit or other functional units after a successful user authentication.

When the login device provides the access information returned from the docbase management system to the current application software unit, it may directly send the access information returned from the docbase management system to the current application software unit. Or, the login device also may preset a shared storage unit with the application software unit, and store the access information returned from the docbase management system in the shared storage unit, from which both the login device and the application software unit may achieve the access information.

In addition, in this step, the access information may be session channel information or other information for security access. The session channel information usually includes the session ID and the session key. The session ID is the unique identifier of the session. The session key is used to authenticate the validity of the session of the user.

The session channel technology of the docbase management system is adopted in this embodiment. Different components or application software units may share logging into the docbase management system via transferring the session key. The session channel technology can better support application software units sharing the role.

Step 105: The current application software unit uses the access information to access the docbase management system.

This step may be implemented with the same methods in existing technologies. No further description is discussed here.

The method may further include step 106. The current application software unit sends a logout request to the current login device when the access terminates. The current login device sends a role logout request to the docbase management system according to the logout request, and deletes the access information corresponding to the role after the role logs out from the docbase management system.

Step 106 is an optional step. When there is the shared storage unit, the access information in the shared storage unit will be deleted when the user logs out if the step 106 is executed; otherwise, the access information in the shared storage unit will not be deleted.

In practical implementation, after accessing the docbase management system via an application software unit, the user may access the docbase management system again through another application software unit. In this case, steps 103-105 or steps 103-106 are performed. If there is a shared storage unit, judge whether there is access information in the shared storage unit after step 103 is executed. If there is the access information, the current application software unit is informed to get the access information from the shared storage unit, and then step 105 or steps 105-106 are executed. If there is not the access information, steps 104-105 or steps 104-106 are executed. The above process may better support application software units share the role.

In the practical implementation, the authentication of multiple roles may be performed at one time. In this case, multiple roles log into the docbase management system at the same time. That is, multiple roles correspond to the same access information.

In an embodiment of present invention, in order to secure the session channel between the login device and the docbase management system and use the session channel information (the session ID and the session key) as the access information, a method for setting up a security session between the login device and the docbase management system is provided. The method including following steps: generating a random PKI key pair including a public key and a private key by either of the login device and the docbase management system, and sending the public key to the other party than the generator of the PKI key pair; generating a random symmetric key as the session key by the receiver of the public key, encrypting the session key with the public key and sending the encrypted session key to the generator of the PKI key pair; and decrypting the received encrypted session key with the private key of the PKI key pair to retrieve the session key by the generator of the PKI key pair.

It can be seen that, by implementing the method above, the session key is unique to the session between the user invoked the login device and the docbase management system, so the session ID, which is also unique to the session, and the session key can be used as the access information. By using the session ID and the session key as the access information, whether it is the same user invoking the login device to get access to the docbase management system can be determined. In this case, when the same user logs into the device through the same or other application system units, the same or another login device retrieves the stored access information and returns the access information to the application software unit.

In an embodiment of present invention, a system and method for document data security management applied to the docbase management system described in the fore-going description is provided. The system for document data security management provided by the present invention is explained herein.

The system for document data security management of the present invention includes a role management unit, a security session channel unit, an identity authentication unit, an access control unit and a signature unit. The role management unit is used for managing at least one role and has the functions of creating a role, granting a privilege to a role and bereaving a role of a privilege. A role can be identified with at least one unique ID and one unique PKI key pair, however, the role object saves only the ID and the public key of the role, the private key of the role is given to the login device. The role can also be identified with a unique ID and a login password, and in such a case the role object saves only the ID and the encrypted login password. The ID of a role can be any number or string as long as different roles are given different IDs. The PKI algorithm can be either ECC algorithm or RSA algorithm.

A number of roles are defined in a docbase and the role objects are sub-objects of the docbase. When corresponding universal document model does not include a docbase object, the roles shall be defined in documents, i.e., the role objects shall be the sub-objects of document objects and all docbases in the document data security management system shall be replaced with documents.

Preferably, all login devices are allowed to create a new role to which no privilege is granted. Certain privileges can be granted to the new role by existing roles with re-license privilege.

The key returned in response to an instruction of creating a role object shall be used for login process, the key should be kept carefully by the login device, and the key is usually a private key of a PKI key pair or a login password.

A special default role can be created in the system for document data security management. When a default role is created, corresponding docbase can be processed with the default role even when no other roles log in. Preferably, a docbase creates a default role with all possible privileges when the docbase is created.

The process performed by the login device from using a role (or roles) to log in so as to performing a number of operations and to logging out is regarded as a session. A session can be identified with session identification and a logged role list. The session can be performed on a security session channel in the security session channel unit which keeps at least a session key for encrypting the data transmitted on the security session channel. The session key may be an asymmetric key, or a commonly used symmetric key with more efficiency.

The identity authentication unit is used for authenticating the identity of a role when the role logs in. The identity authentication is role oriented and any role except the default role may log in only after presenting the key of the role. When a role wants to log in and the key of the role is a PKI key, the identity authentication unit retrieves the public key of the role from the role object according to the role ID and authenticates the identity of the role by using the “challenge-response” mechanism described in the fore-going description; when the key of the role is a login password, the identity authentication unit retrieves the public key of the role from the role object according to the role ID and draws comparison.

The login device may log in as multiple roles at the same time and the privileges granted to the login device shall then be the union of the privileges of the roles.

The access control unit is used for setting an access control privilege for document data, and a role can only access document data according to the access control privilege granted to the role. The privilege data can be managed by the access control unit so that some roles may acquire the privilege of other role and some roles may not. A role can modify privileges of other roles in normal re-license or bereave process only when the role is granted re-license privilege or bereave privilege; directly writing data into the privilege data is not allowed.

An access privilege for any role on any object (a docbase, docset, document, page, layer, object group, layout object) can be set up, and if a privilege on an object is granted to a role, the privilege can be inherited by all sub-objects of the object.

Access privileges include any one or any combination of the following privileges: read privilege (whether a role may read data), write privilege (whether a role may write into data), re-license privilege (whether a role may re-license, i.e., grant part of or all the privileges of the role to another role), bereave privilege (whether a role may bereave of privilege, i.e., delete a part or all of the privileges of another role) and print privilege (whether a role may print data), and the present invention does not limit the privileges. Preferably, a docbase creates a default role with all possible privileges when the docbase is created so that the creator of the docbase has all privileges on the docbase.

The signature unit is used for attaching a signature to any logical data specified among the document data in the system for document data security management. A role signature can be attached by the signature unit with corresponding private key and the validity of the role signature on the logical data can be verified with the public key.

The role signature can be attached to all objects. The signature covers the sub-objects of the signed object and the objects referenced by the signed object.

The method for document data security management is further explained herein with reference to the system for security management described above.

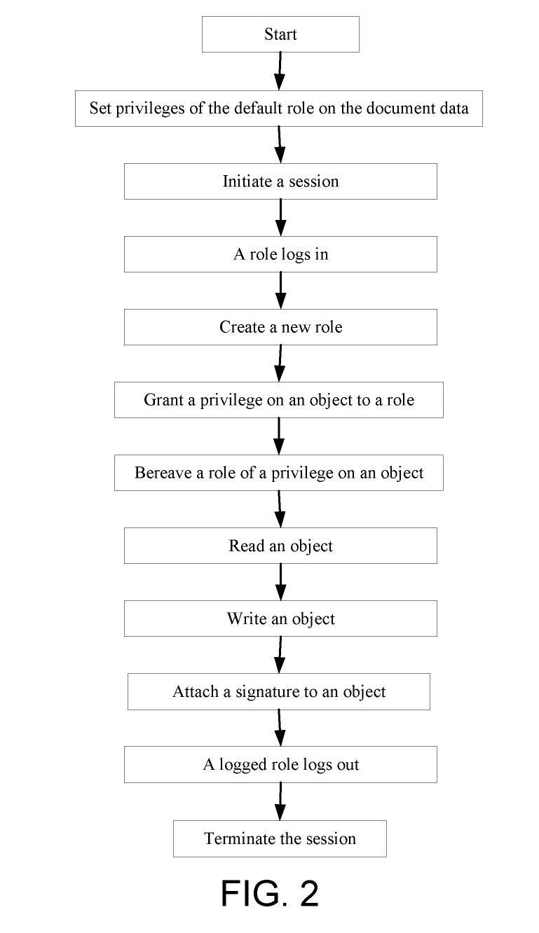

As shown in FIG. 2, the method for document data security management of the present invention includes the following steps:

1. When a docbase is created, the role management unit automatically grants all possible privileges on the docbase, including read privilege, write privilege, re-license privilege and bereave privilege on all objects, to the default role of the docbase.

2. The security session channel unit sets up a security session channel between the login device and the docbase management system and initiates a session.

a) Determine whether the session has been successfully initiated according to session identification; if the session has been successfully initiated, the security session channel setup process shall end, otherwise the security session channel setup process shall proceed.

b) Either the login device or the docbase management system generates a random PKI key pair.

c) The party which generates the random PKI key pair sends the public key of the PKI key pair to the other party.

d) The other party generates a random symmetric key as the session key, encrypts the session key with the public key and sends the encrypted session key to the party which generates the random PKI key pair.

e) The party which generates the random PKI key pair decrypts the encrypted session key with the private key of the PKI key pair.

f) Set up session identification.

g) Set the logged role list as the default role.

3. Role logs in

a) The login device provides the ID of a role that shall log in and a docbase in which the role shall log.

b) The identity authentication unit checks the logged role list of the session, if the role (including the default role) has logged in, this step shall end, otherwise this step shall proceed.

c) When the key of the role is a PKI key, the identity authentication unit retrieves the public key of the role from the role object; when the key of the role is a login password, proceed Step h) directly.

d) The identity authentication unit generates a random data block and encrypts the data block with the public key of the role.

e) The identity authentication unit sends the encrypted data block to the login device.

f) The login device decrypts the encrypted data block with the private key of the role and sends the decrypted data back to the identity authentication unit.

g) The identity authentication unit checks whether the returned data is correct, and if the data is incorrect, the role will fail to log in, otherwise directly proceed Step i).

h) The login device provides a login password and the identity authentication unit compares the login password saved in the role object with the login password provided by the login device, if the two passwords are identical, the login process shall proceed; otherwise the role will fail to log in.

i) Add the role into the logged role list of the session.

4. Create a new role

a) The login device issues an instruction of creating a new role.

b) The role management unit generates a unique role ID.

c) When the instruction requires the key of the to-be-created role to be a PKI key, the role management unit generates a random PKI key pair; when the instruction requires the key of the to-be-created role to be a login password, the login password of the role shall be the password specified by the instruction or generated at random by the role management unit.

d) The role management unit creates a role object in the docbase and saves the ID and the key (the public key or login password) in the role object, and the privilege of the role is null, i.e., the role has no privilege on any object.

e) Return the ID and the key (the private key or login password) to the login device.

5. Grant a privilege P on an object O to a role R

When granting a privilege on an object, the simplest method includes: recording the privileges of each role on the object (including the sub-objects thereof) and comparing the privileges of each role when the role log in, if an operation within the privileges, the operation shall be accepted, otherwise error information shall be returned. A preferred method applied to the present invention includes: encrypting corresponding data and controlling privileges with a key, when a role cannot present a correct key, the role does not have corresponding privilege. This preferred method provides better anti-attack performance.

a) The login device sends a privilege request.

b) The role management unit obtains the union of the privileges of all roles in the logged role list on the object O and determines whether the union is a superset of the privilege P and whether the union includes re-license privilege. If the union is a superset of the privilege P and the union includes the re-license privilege, the process shall proceed, otherwise the granting of the privilege will fail (because the privileges of all the roles still do not include a privilege used for granting).

c) The role management unit adds the privilege P on the object O into the privilege list of the role R. If the privilege P does not include read or write privilege, the privilege granting process is completed, otherwise the process continues.

d) The access control unit checks whether read/write access control privilege is set up on the object O. If no read/write access control privilege is set up on the object O, steps as follows shall be performed.

i. Generate a random symmetric key and a random PKI key pair.

ii. Encrypt the object O with the symmetric key; if the read/write access control privilege is set up on a subobject of the object O, the subobject shall remain unchanged.

A PKI key pair shall be generated for a data sector to be protected (usually a subtree corresponding to an object and the subobjects thereof), and the data sector is encrypted with the encryption key of the PKI key pair.

iii. Encrypt the symmetric key with the encryption key of the PKI key pair, save the encryption word and sign the target object to obtain a signature.

iv. Check all roles in the docbase. If a role has read privilege on object O (here the object O may be a subobject of the object on which the role has the read privilege), the decryption key shall be encrypted with the public key of the role and encryption word of the decryption key is saved in the privilege list of the role. If a role has write privilege on object O (here the object O may be a subobject of the object on which the role has the write privilege), the encryption key shall be encrypted with the public key of the role and encryption word of the encryption key is saved in the privilege list of the role.

v. Proceed Step h).

e) Choose a role that has needed privilege (the read privilege or write privilege) on the object O from all logged roles.

f) Obtain the encryption word of a corresponding key corresponding to the object O from the privilege list of the role (the read privilege requires the decryption key and the write privilege requires the encryption key, the combination of the read privilege and write privilege requires both keys), if the key of the role is a PKI key, the encryption word of the corresponding key is sent to the login device and Step g) is performed; if the key of the role is a login password, the access control unit decrypts the encryption word of the corresponding key and then Step h) is performed.

When a role is granted the read privilege, the decryption key of the PKI key pair is passed to the role and the role may decrypt the data sector with the decryption key to read the data correctly. When a role is granted the write privilege, the encryption key of the PKI key pair is passed to the role and the role may encrypt modified data with the encryption key in order to write data into the data sector correctly.

g) The login device decrypts encryption word of the corresponding key with the private key of the role to retrieve the key and returns the key to the access control unit.

h) The access control unit encrypts corresponding key according to the privilege P, generates corresponding encryption word of the corresponding key and saves the encryption word into the privilege list of the role R.

When a role is given an encryption key or decryption key, the encryption key or decryption key may be saved after being encrypted with the public key of the role, so that the encryption key or decryption key can only be retrieved with the private key of the role.

Since the encryption/decryption efficiency of the PKI keys is low, a symmetric key may be used for encrypting the data sector and the encryption key further encrypts the symmetric key while the decryption key may decrypt the encrypted key data to retrieve the correct symmetric key. The encryption key may be further used for attaching a digital signature to the data sector to prevent a role with read privilege only from modifying the data when the role is given the symmetric key. In such case a role with write privilege attaches a new signature to the data sector every time when the data sector is modified; therefore the data will not be modified by any role without write privilege.

6. Bereave a role R of a privilege P on an object O

a) The login device sends a request of bereaving of a privilege.

b) The role management unit checks all roles in the logged role list to determine whether there is a role has a bereave privilege on the object O. If no role has the bereave privilege, the process of bereaving of the privilege will fail, otherwise the process continues.

c) Delete the privilege P from the privileges of the role Ron the object O.

d) If the privilege P includes read or write privilege, corresponding decryption key or encryption key for the object O shall be removed from the privilege list of the role R.

7. Read an object O

a) The login device sends an instruction of reading the object O.

b) The access control unit checks the privileges of all roles in the logged role list on the object O and determines whether there is at least one role in the logged role list has read privilege on the object O. If no role has the read privilege, the reading process fails; otherwise the process continues.

c) Check whether read/write access control privilege is set up on the object O. If no read/write access control privilege is set up, check the parent object of the object O and the parent object of the parent object until an object with the read/write access control privilege is found.

d) Choose a role that has the read privilege on the found object.

e) Extract the encryption word of the decryption key of the found object from the privilege list of the role, when the key of the role is a PKI key, the encryption word of the decryption key is sent to the login device and Step f) is performed; when the key of the role is a login password, the access control unit decrypts the encryption word of the decryption key and Step g) is performed.

f) The login device decrypts the encryption word of the decryption key with the private key of the role to retrieve the decryption key and returns the decryption key to the access control unit.

g) The access control unit decrypts encryption word of the symmetric key of the object with the decryption key to retrieve the symmetric key of the object.

h) Decrypt encryption word of the data of the object O with the symmetric key to retrieve the data of the object O.

i) Return the decrypted data of the object O to the login device.

8. Write an object O

a) The login device sends an instruction of writing into the object O.

b) The access control unit checks the privileges of all roles in the logged role list on the object O and determines whether there is at least one role in the logged role list has write privilege on the object O. If no role has the write privilege, the writing process fails, otherwise the process continues.

c) Check whether read/write access control privilege is set up on the object O. If no read/write access control privilege is set up, check the parent object of the object O and the parent object of the parent object until an object O1 with the read/write access control privilege is found.

d) Choose a role that has the write privilege on the object O1.

e) Extract the encryption word of the encryption key of the object O1 from the privilege list of the role. When the key of the role is a PKI key, the encryption word of the encryption key is sent to the login device and Step f) is performed. When the key of the role is a login password, the access control unit decrypts the encryption word of the encryption key and Step g) shall be performed.

f) The login device decrypts the encryption word of the encryption key with the private key of the role to retrieve the encryption key of the object O1 and returns the encryption key of the object O1 to the access control unit.

g) Encrypt modified data of the object O with the encryption key of the object O1 (if read/write access control privilege is set up on a subobject of the object O, the subobject is encrypted with the original key of the subobject).

h) Overwrite the original data with the encrypted data and the writing process shall end.

9. Sign an object O to obtain a signature

a) The login device sends an instruction of signing an object O to obtain a signature.

b) The access control unit regularizes the data of the object O.

When a signature is attached to an object, the signature shall be attached to the subtree starting from the node corresponding to the object. The regularization should be done first so that the signature will be free from being affected by physical storage variation, i.e., by logically equivalent alterations (e.g., change of pointer caused the change of storage position). The regularization method is given in the fore-going description.

c) Calculate HASH value of the regularization result.

d) Send the HASH value to the login device.

e) The login device encrypts the HASH value with the private key of the role (i.e., the signature) when the key of the role in the logged role list is a PKI key.

f) The login device returns the signature result to the access control unit

g) The access control unit saves the signature result in a digital signature object.

10. log out a logged role

a) The login device sends an instruction for logging out a logged role.

b) The security session channel unit deletes the logged role from the logged role list if the logged role list includes the logged role.

11. Terminate session

a) Either the login device or the docbase management system sends a session termination request.

b) The security session channel unit terminates all threads related to the present session, erases the session identification and deletes the logged role list.

The above embodiments describe the method for logging into the docbase management system. In the following, a system for logging into the docbase management system provided in one embodiment of the present invention will be described in details.

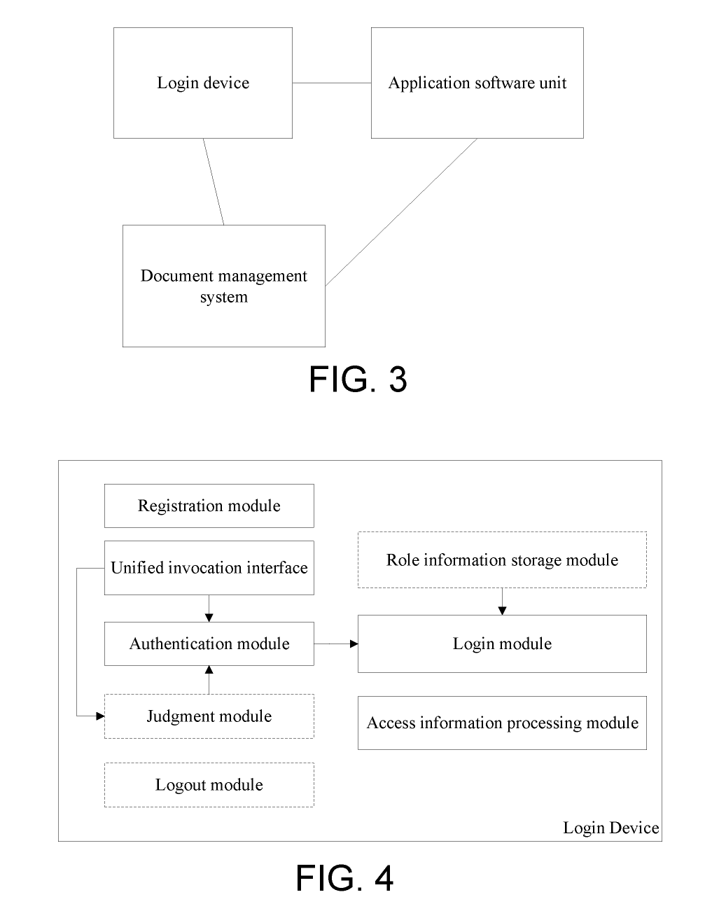

FIG. 3 illustrates the structure diagram of the system for logging into the docbase management system provided in one embodiment of the present invention. As shown in FIG. 3, the system includes: a docbase management system, at least one login device, and at least one application software unit.

In an embodiment of the present invention, the system for logging into the docbase management system is applied to a document processing system including at least one client side and a server side. The docbase management system is established on the server side, and the at least one login device is established on a client side.

Each login device has a unified invocation interface; and is registered in the computer system according to a method predetermined with the application software units. When invoked by a user for the first time through an application software unit, the login device is adopted to authenticate the user, log into the docbase management system by using role information corresponding to the said user after a successful authentication, and store the access information returned from the docbase management system after a successful login; when invoked again by the user again through the same or other application software units, retrieve the stored access information and returning the access information to the same or other application software units. The operation process of the login device is similar with the method described in FIG. 1. No further details will be discussed here.

The application software unit is adapted to travers the login devices registered in the computer system according to a predetermined method, determine the current login device, invoke the current login device through its unified invocation interface ; obtain the access information provided by the current login device, and use the access information to access the docbase management system. The operation process of the application software unit may be implemented as described in FIG. 1. No further details will be discussed here.

Corresponding to the method shown in FIG. 1, the system may further include: a shared storage unit, adapted to store the access information returned from the docbase management system. In this case, the login device may store the access information returned from the docbase management system in the shared storage unit. Correspondingly, the application software unit may achieve the access information from the shared storage unit.

Corresponding to the method shown in FIG. 1, before the user authentication, the login device may be further adapted to judge whether there is the access information in the shared storage unit. If there is the access information in the shared storage unit, and return the access information to the same or other application software units; otherwise, authenticate the user and log into the docbase management system.

Corresponding to the method shown in FIG. 1, the application software unit may be further adapted to send a logout request to the current login device when the access terminates. Correspondingly, the login device is adapted to send a role logout request to the docbase management system according to the logout request, and deletes the access information corresponding to the role after the role logs out from the docbase management system.

In practice, the structure of the login device in an embodiment of the present invention may be implemented in many forms. FIG. 4 illustrates one structure diagram of the login device provided in an embodiment of the present invention. As shown in FIG. 4, the login device includes: a unified invocation interface, a registration module, an authentication module, a login module, and an access information processing module.

The unified invocation interface is adapted for invoking the login device by an application software unit.

The registration module is adapted to register the login device in the computer system according to a method predetermined with the application software unit.

The authentication module is adapted to authenticate a user according to stored authentication information.

The login module is adapted to log into the docbase management system by using role information of the document management corresponding to the user after a successful authentication, and store the access information from the docbase management system after a successful login.

The access information processing module is adapted to retrieve the stored access information when the user logs in again through the same or other application software units, and return the access information back to the same or other application software units.

The operation process of the registration module may be as described in the step 102. The operation process of the authentication module, the login module, and the access information processing module may be similar with the step 104.

The login device may further include: a role information storage module, adapted to store the corresponding relation between users and role information of the docbase management system. Correspondingly, the login module is further adapted to achieve the role information of the docbase management system corresponding to the user from the role information storage module after the authentication module performs a successful authentication.

If there is a shared storage unit shared by the login device and the application software unit, the access information processing module may store the access information in the shared storage unit. In this case, the login device may further include: a judgment module, adapted to judge whether there is the access information in the shared storage unit, if there is, obtain the stored access information, and return the access information to the same or other application software units; otherwise, authenticate the user and log into the docbase management system.

The login device may further include: a logout module, adapted to receive a logout request from the same or other application software units, send a role logout request to the docbase management system based on the logout request, and delete the access information of the document management role corresponding to the user after the docbase management system logs out the role.

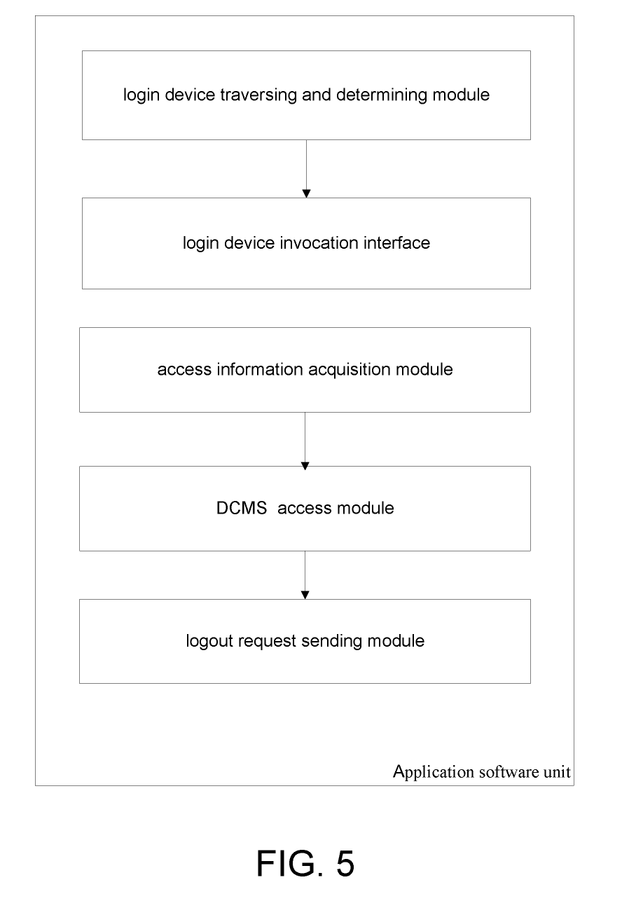

In practice, the structure of the application software unit in an embodiment of the present invention may be implemented in many forms. FIG. 4 illustrates a structure diagram of the application software unit disclosed in an embodiment of the present invention. As shown in FIG. 5, the application software unit includes: a login device traversing and determining module, a login device invocation interface, an access information acquisition module and a document management access module.

The login device traversing and determining module is adapted to traverse login devices registered in the computer system according to a predetermined method with the login devices, and determine one login device as the current invoked login device.

The login device invocation interface is adapted to invoke the current invoked login device via a unified invocation interface.

The access information acquisition module is adapted to obtain access information from the docbase management system from the current invoked login device.

The document management access module is adapted to access the docbase management system by using the access information. Specifically, the access information may be sent by the login device directly to the access information acquisition module, or be obtained by the access information acquisition module from the shared storage unit between the login device and the application software unit.

The application software unit may further include: a logout request sending module, adapted to send a logout request to the login device after the access is completed.

The skilled in the art can understand that the drawings are just the schematic diagram of preferred embodiments. The modules or processes in the drawings may be unnecessary. It should be understood that the embodiments offered herein are used for explaining the present invention only and shall not be used for limiting the protection scope of the present invention.

The skilled in the art can understand that the modules of the devices in the embodiments may be distributed in devices as the description of the present embodiment, and also may be located in one or multiple devices different from the embodiments according to corresponding changes. The modules of the abovementioned embodiments may be combined into one module, or be further split into many sub-modules.

The serial number of the embodiments in the present invention is only for description, and does not indicate the merit of the embodiment.

Some of the steps in the embodiment of the present invention may be implemented via software. The corresponding software program may be stored in the readable storage medium, such as CDs and hard disks.

The above embodiments give a detailed description of the purpose, technical scheme, and beneficial effects of the present invention. The above content only includes preferred embodiments of the present invention. The content is not used to limit the protection scope of the protection. Any modification, replacement, and improvement made under the design idea and the design principle will be considered to be within the protection scope of the present invention.

1. A method for logging into a docbase management system, wherein the docbase management system is established on a server side and the method comprises:
establishing a login device, which has a unified invocation interface, on a client side;
invoking, by a user, the login device via an application software unit, wherein the application software unit invokes the login device via the unified invocation interface;
returning, by the login device, to the application software unit, access information of a role corresponding to the user achieved after successfully logging in the docbase management system;
accessing, by the application software unit, the docbase management system by using the access information;
when invoked by a user at the first time via an application software unit, authenticating, by the login device, the user, and logging into the docbase management system by using role information of the docbase management system corresponding to the user after a successful authentication; returning, by the login device, the access information corresponding to the user from the docbase management system to the application software unit, and storing the access information; when invoked again by the user via another application software unit, retrieving, by the login device, the stored access information and returns the access information back to the another application software unit used by the user who invokes again.

2. The method of claim 1, further comprising:
registering at least one login device in the computer system according to a predetermined method with each application software unit;
traversing, by the application software unit, the login devices registered in the computer system according to a predetermined method, and determining one login device as the current invoked login device.

3. The method of claim 2, wherein, registering at least one login device in the computer system according to a predetermined method with the application software unit comprises:
registering the location information of the login devices in the registry of the computer system according to a predetermined method with the application software unit.

4. The method of claim 2, wherein, registering at least one login device in the computer system according to a predetermined method with the application software unit comprises:
registering the location information of the login devices in a predetermined directory of the computer system according to a predetermined method with the application software unit.

5. The method of claim 2, wherein, registering at least one login device in the computer system according to a predetermined method with the application software unit comprises:
installing the login devices in a predetermined directory of the computer system according to a predetermined method with the application software unit.

6. The method of claim 2, wherein, determining one login device as the current invoked login device comprises: providing the information of the login devices traversed to the user, and determining the login device selected by the user as the current invoked login device.

7. The method of claim 1, wherein, before logging into the docbase management system by using role information of the docbase management system corresponding to the user after a successful authentication, the method further comprises:
acquiring the role information corresponding to the user according to the corresponding relation between users and role information of the docbase management system stored in the login device or the application software unit.

8. The method of claim 1, wherein, authenticating, by the login device, the user comprises: authenticating, by the login device, the user according to authentication information irrelevant to the application software unit and stored in the login device.

9. The method of claim 1, wherein, storing the access information comprises: storing the access information in a shared storage unit of the login device and the application software unit;
retrieving, by the login device, the stored access information and returns the access information back to an application software unit who invokes comprises:
acquiring the access information from the shared storage unit, and returning the access information to the application software unit.

10. The method of claim 1, further comprising:
sending, by the application software unit, a logout request to the login device;
sending, by the login device, the role logout request to the docbase management system according to the logout request, deleting the access information of the document management role corresponding to the user after the docbase management system logs out the role.

11. The method of claim 1, wherein, the access information is session channel information of the docbase management system.

12. A login device for logging into a docbase management system, wherein the docbase management system is established on a server side and the login device comprises:
a unified invocation interface, adapted for invoking the login device by an application software unit;
an authentication module, adapted to perform user authentication when logged into by a user through the application software unit at the first time;
a login module, adapted to log into the docbase management system by using role information of the document management corresponding to the user after a successful authentication, and store the access information from the docbase management system after a successful login;
an access information processing module, adapted to retrieve the stored access information when the user logs in again through another application software unit, and return the access information back to the another application software unit.

13. The login device of claim 12, further comprising:
a registration module, adapted to register the login device in the computer system according to a method predetermined with the application software unit.

14. The login device of claim 13, further comprising:
a role information storage module, adapted to store the corresponding relation between users and role information of the docbase management system;
the login module, further adapted to achieve the role information of the docbase management system corresponding to the user from the role information storage module after the authentication module performs a successful authentication.

15. The login device of claim 14, further comprising:
a judgment module, adapted to judge whether the access information exists in the system, if the access information exists, obtain the stored access information, and return the access information to the same or other application software units; otherwise, authenticate the user and log into the docbase management system.

16. The login device of claim 12, further comprising:
a logout module, adapted to receive a logout request from the same or other application software units, send the role logout request to the docbase management system, and delete the access information of the document management role corresponding to the user after the docbase management system logs out the role.

17. A system for logging into a docbase management system, wherein the docbase management system is established on a server side and the system for logging into the docbase management system comprises: at least one login device established on a client side and at least two application software units;
wherein the login device comprises:
a unified invocation interface, adapted for invoking the login device by the at least two application software units;
an authentication module, adapted to perform user authentication when logged into by a user through an application software unit of at least two application software units at the first time;
a login module, adapted to log into the docbase management system by using role information of the document management corresponding to the user after a successful authentication, and store the access information from the docbase management system after a successful login; and
an access information processing module, adapted to retrieve the stored access information when the user logs in again through another application software unit of the at least two application software units, and return the access information back to the another application software unit;
wherein the application software unit comprises:
a login device invocation interface, adapted to invoke the at least one login device via a unified invocation interface;
an access information acquisition module, adapted to obtain access information from the docbase management system from the at least one login device; and
a document management access module, adapted to access the docbase management system by using the access information.

18. The system for logging into the docbase management system of claim 17, wherein the application software unit further comprises:
a login device traversing and determining module, adapted to traverse login devices registered in the computer system according to a predetermined method with the login devices, and determine one login device as the current invoked login device.

19. The system for logging into the docbase management system of claim 18, wherein the application software unit further comprises:
a logout request sending module, adapted to send a logout request to the at least one login device after the access is completed.
